(19) United States
(12) Patent Application Publication
(10) Pub. No.: US 2015/0222815 A1
(43) Pub. Date: Aug. 6, 2015

(54) ALIGNING VIDEOS REPRESENTING DIFFERENT VIEWPOINTS

(71) Applicant: NOKIA CORPORATION, Espoo (FI)

(72) Inventors: Kong Qiao Wang, Beijing (CN); Leo Karkkainen, Helsinki (FI)

(21) Appl. No.: 14/366,361

(22) PCT Filed: Dec. 23, 2011
(86) PCT No.: PCT/FI2011/051153

§ 371 Date: Nov. 3, 2014

(51) Int. Cl. H04N 5/232; H04N 21/218; H04N 5/272

(52) U.S. Cl. CPC H04N 5/23238; H04N 5/272; H04N 21/21805

(57) ABSTRACT

A method for obtaining a plurality of source videos in a processing device (700), determining suitability of the source videos to form a panorama or multi-angle video remix from an event (702), selecting (704) and aligning (706) at least two of the suitable source videos. The suitable source videos represent respective watching angles or viewpoints to the event. The suitability of the source videos can be determined using location metadata or the presence of a common audio scene.

### TECHNICAL FIELD

Various embodiments generally relate to image processing and, more particularly, to panorama.

### BACKGROUND

Video remixing is an application where multiple video recordings are combined in order to obtain a video mix that contains some segments selected from the plurality of video recordings. Video remixing, as such, is one of the basic manual video editing applications, for which various software products and services are already available. Furthermore, there exist automatic video remixing or editing systems, which use multiple instances of user-generated or professional recordings to automatically generate a remix that combines content from the available source content.

Video remixing can be applied, for example, to creating a video remix from a plurality of user-generated video captures from the same event, for example a concert. People attending the concert may upload videos captured with their own cameras to a server, and then the video editing and metadata extraction are carried out by a video remixing application on the server so that videos tagged with smart metadata about the concert can be ready for download/sharing, either as such or as a remix from a plurality of video captures.

However, the video captures uploaded on the server typically have a lot of redundancy in their information content, for example, due to the fact that many people capture their video recording from approximately the same location. Thus, the concert will be multiply captured from a certain viewpoint at a certain time period. The data redundancy will make the server bulky, and can easily make users lost in video downloading as well.

A further problem is that if a user downloads a video remix from the server, the user is always limited to watch the event from viewpoint selected by the video remixing application. If the user wants to watch the event from another angle, he/she needs to download another video capture or a video remix from the server.

### SUMMARY

Now there has been invented an improved method and technical equipment implementing the method for alleviating the above problems. Various aspects of the invention include methods, apparatuses, and computer programs, which are characterized by what is stated in the independent claims. Various embodiments of the invention are disclosed in the dependent claims.

According to a first aspect, there is provided a method comprising: obtaining a plurality of source videos in a processing device; determining suitability of the source videos to form a panorama video remix from an event; selecting at least two suitable source videos for the panorama video remix; and merging said at least two suitable source videos on a frame level into the panorama video remix, wherein the frames of each source video represent a watching angle to the event.

According to an embodiment, the suitability of the source videos to form the panorama video remix from the event is determined according to at least one of the following:
similarity of location information of a plurality of the source videos; or
presence of a common audio scene in a plurality of the source videos.

According to an embodiment, the location information is obtained from metadata of the source videos, said location information being recorded simultaneously with the source video.

According to an embodiment, the method further comprises comparing similarities of the audio scenes of at least two source videos; and determining, on the basis of a predefined amount of similarities, that said at least two source videos are from the same event.

According to an embodiment, the method further comprises estimating, from the source videos, a capturing distance between an image capturing device and a captured object of interest; and selecting a number of source videos having the capturing distance within a predefined range to be used in the panorama video remix.

According to an embodiment, the method further comprises searching for a common captured object of interest from the frames of at least two source videos, said at least two videos being captured with different capturing distance; in response to detecting at least one common captured object of interest from the frames of said at least two source videos, applying at least one affine transform process to said frames of said at least two source videos in order to transform said at least one common captured object of interest in a compatible scale; and selecting said at least two source videos to be used in the panorama video remix.

According to an embodiment, the selected source videos have different frame rates and the panorama video remix has a variable frame rate.

According to an embodiment, the method further comprises analysing audio scenes of the selected source videos; and in response to detecting a common audio component, aligning the source videos in time axis on the basis of the common audio component.

According to an embodiment, the method further comprises determining a time interval, wherein the frames of the source videos within said time interval are contributable to a panorama video frame; and selecting at least one of frames of the source videos within said time interval be used for creating a single panorama video frame.

According to an embodiment, the method further comprises receiving a first user request for downloading the panorama video remix, said user request including a request to download the panorama video remix from a first watching angle; and starting to download, from the panorama video remix, only the frames of the source video representing the requested first watching angle.

According to an embodiment, the method further comprises receiving a second user request for downloading the panorama video remix from a second watching angle; stopping to download the frames of the source video representing the requested first watching angle; and starting to download, from the panorama video remix, only the frames of the source video representing the requested second watching angle.

According to a second aspect, there is provided an apparatus comprising at least one processor, memory including computer program code, the memory and the computer program code configured to, with the at least one processor, cause the apparatus to at least: obtain a plurality of source videos; determine suitability of the source videos to form a panorama video remix from an event; select at least two suitable source videos for the panorama video remix; and merge said at least two suitable source videos on a frame level into the panorama video remix, wherein the frames of each source video represent a watching angle to the event.

According to a third aspect, there is provided a computer program embodied on a non-transitory computer readable medium, the computer program comprising instructions causing, when executed on at least one processor, at least one apparatus to: obtain a plurality of source videos; determine suitability of the source videos to form a panorama video remix from an event; select at least two suitable source videos for the panorama video remix; and merge said at least two suitable source videos on a frame level into the panorama video remix, wherein the frames of each source video represent a watching angle to the event.

According to a fourth aspect, there is provided a method comprising: sending a first user request for downloading a panorama video remix from a server, said user request including a request to download the panorama video remix from a first watching angle; downloading, from the panorama video remix, only frames of a source video representing the requested first watching angle to the apparatus; and arranging the frames representing the first watching angle to be displayed on the apparatus.

According to a fifth aspect, there is provided an apparatus comprising at least one processor, memory including computer program code, the memory and the computer program code configured to, with the at least one processor, cause the apparatus to at least: send a first user request for downloading a panorama video remix from a server, said user request including a request to download the panorama video remix from a first watching angle; download from the panorama video remix, only frames of a source video representing the requested first watching angle to the apparatus; and arrange the frames representing the first watching angle to be displayed on the apparatus.

These and other aspects of the invention and the embodiments related thereto will become apparent in view of the detailed disclosure of the embodiments further below.

### BRIEF DESCRIPTION OF DRAWINGS

In the following, various embodiments of the invention will be described in more detail with reference to the appended drawings, in which

FIGS. 1a and 1b show a system and devices suitable to be used in a panorama video remixing service according to an embodiment;

FIG. 2 shows a block chart of an implementation embodiment for the panorama video remixing service;

FIG. 3 shows creation of frames of the panorama video remix according to an embodiment using time-corresponding frames of the selected source frames;

FIG. 4 shows a time interval for selecting the frames of the source videos to be used for creating a single panorama video frame according to an embodiment;

FIG. 5 shows an example of a user interface of a panorama video player application implemented on a mobile phone;

FIG. 6 shows a panorama video frame according to an embodiment on a conceptual level;

FIG. 7 shows a flow chart of an embodiment for creating the panorama video remix; and

FIG. 8 shows a flow chart of an embodiment for browsing the panorama video remix on an apparatus.

### DESCRIPTION OF EMBODIMENTS

As is generally known, many contemporary portable devices, such as mobile phones, cameras, tablet comptures, are provided with high quality cameras, which enable to capture high quality video files and still images. In addition to the above capabilities, such handheld electronic devices are nowadays equipped with multiple sensors that can assist different applications and services in contextualizing how the devices are used. Furthermore, many portable devices are equipped with means for determining the location of the device, such as GPS receivers.

Usually, at events attended by a lot of people, such as live concerts, sport games, social events, there are many who record still images and videos using their portable devices. Recordings of the attendants from such events provide a suitable framework for the present invention and its embodiments.

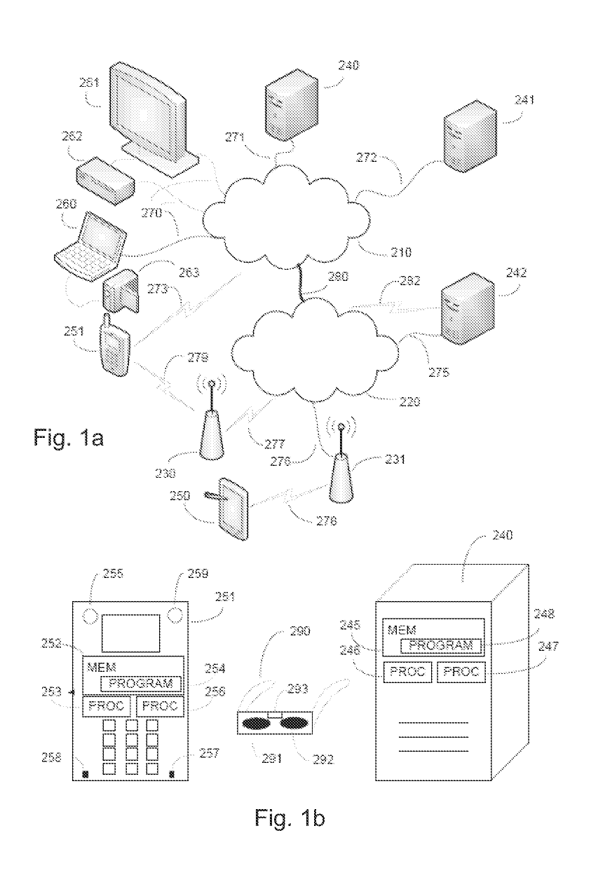

FIGS. 1a and 1b show a system and devices suitable to be used in a video remixing service according to an embodiment. In FIG. 1a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data, and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1a are shown servers 240, 241 and 242, each connected to the mobile network 220, which servers may be arranged to operate as computing nodes for the video remixing service. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices, for example Internet tablet computers 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 1b shows devices for the video remixing according to an example embodiment. As shown in FIG. 1b, the server 240 contains memory 245, one or more processors 246, 247, and computer program code 248 residing in the memory 245 for implementing, for example, automatic video remixing. The different servers 241, 242, 290 may contain at least these elements for employing functionality relevant to each server.

Similarly, the end-user device 251 contains memory 252, at least one processor 253 and 256, and computer program code 254 residing in the memory 252 for implementing, for example, gesture recognition. The end-user device may also have one or more cameras 255 and 259 for capturing image data, for example stereo video. The end-user device may also contain one, two or more microphones 257 and 258 for capturing sound.

The end user devices may also comprise a screen for viewing single-view, stereoscopic (2-view), or multiview (more-than-2-view) images. The end-user devices may also be connected to video glasses 290 e.g. by means of a communication block 293 able to receive and/or transmit information. The glasses may contain separate eye elements 291 and 292 for the left and right eye. These eye elements may either show a picture for viewing, or they may comprise a shutter functionality e.g. to block every other picture in an alternating manner to provide the two views of three-dimensional picture to the eyes, or they may comprise an orthogonal polarization filter (compared to each other), which, when connected to similar polarization realized on the screen, provide the separate views to the eyes. Other arrangements for video glasses may also be used to provide stereoscopic viewing capability. Stereoscopic or multiview screens may also be autostereoscopic, i.e. the screen may comprise or may be overlaid by an optics arrangement, which results into a different view being perceived by each eye. Single-view, stereoscopic, and multiview screens may also be operationally connected to viewer tracking such a manner that the displayed views depend on viewer's position, distance, and/or direction of gaze relative to the screen.

It needs to be understood that different embodiments allow different parts to be carried out in different elements. For example, various processes of the video remixing may be carried out in one or more processing devices; for example, entirely in one user device like 250, 251 or 260, or in one server device 240, 241, 242 or 290, or across multiple user devices 250, 251, 260 or across multiple network devices 240, 241, 242, 290, or across both user devices 250, 251, 260 and network devices 240, 241, 242, 290. The elements of the video remixing process may be implemented as a software component residing on one device or distributed across several devices, as mentioned above, for example so that the devices form a so-called cloud.

An embodiment relates to a method for creating a panorama video remix providing a variety of viewpoints, for example different watching angles from an event. In the method, the uploaded videos are appropriately analyzed and a panorama video remix is created, which preferably covers as wide panorama scope of the event as possible. After the analysis, two or more, for example, 2, 3, 4, 5, 6, 7, 8, 9, 10 or more, uploaded video captures are selected as source videos for the panorama video, and the selected source videos are then combined into the panorama video at frame level. If necessary, the uploaded videos from users can thereafter be discarded in order to save memory resources of the server. After having started the downloading of the panorama video, a user can select any angle to watch the event freely based on the available panorama video.

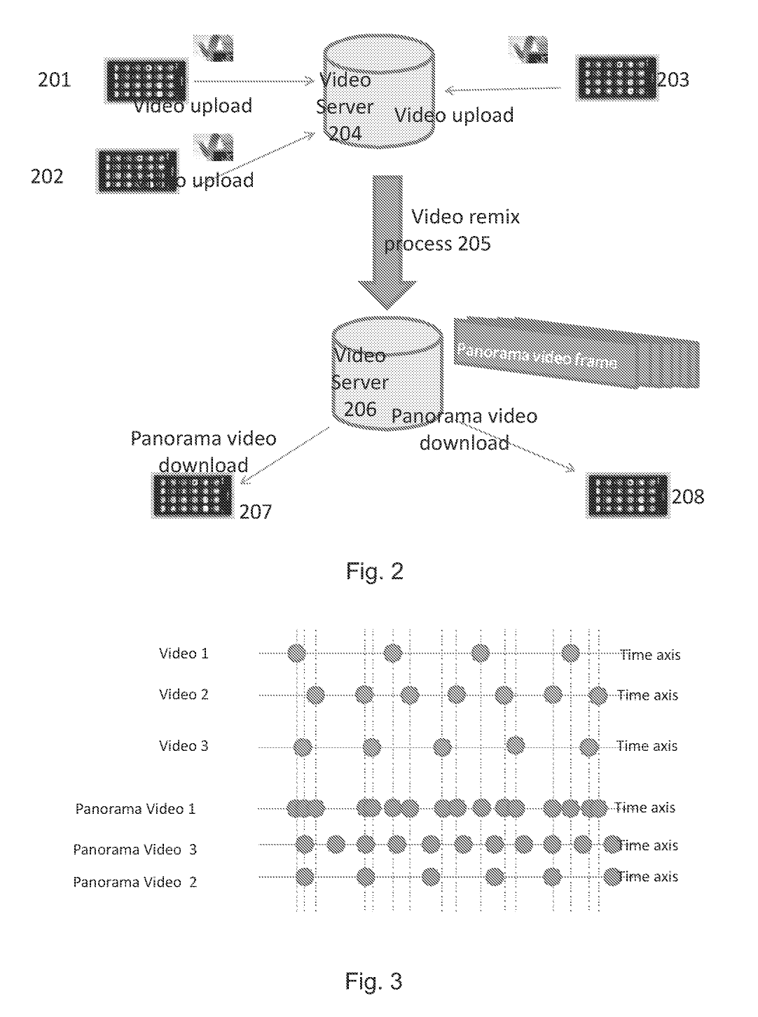

The implementation of the panorama video remix as described above is now illustrated more in detail by referring to FIG. 2, which discloses an example of the implementation for the panorama video remixing service. There are a plurality of video capturing devices 201, 202, 203, such as mobile phones equipped with a camera, capturing video content from the same event, for example a concert. The captured videos are uploaded in a video server 204 as a plurality of source videos for the panorama video remix. Even though FIG. 2 shows, in an exemplified manner, a plurality of mobile phones as the video capturing devices, it is noted that the source videos may be originated from one or more end-user devices or they may be loaded from a computer or a server connected to a network. The source videos may, but not necessarily need to be encoded, for example, by any known video coding standard, such as MPEG 2, MPEG4, H.264/AVC, etc.

The source videos are subjected to a video remix process 205 for creating a panorama video remix. The video remix process may be performed by a video remix application, which may consist of one or more application programs, which may be distributed among one or more data processing devices. The video remix process may be divided into several sub-processes, which may include at least extracting metadata from the source videos, selecting the source videos to be used in the panorama video remix, editing the video data obtained from the source videos and creating the panorama video remix.

In order to create a panorama video remix, it has to be determined which source videos can reasonably be attached together; i.e. which source videos are originated from the same event. A plurality of end-user image/video capturing devices may be present at an event. According to an embodiment, source videos originated from the same event can automatically be detected based on the substantially similar location information (e.g., from GPS or any other positioning system) or via presence of a common audio scene. According to an embodiment, the source videos may contain metadata data comprising at least location information, such as GPS sensor data preferably recorded simultaneously with the video and having synchronized timestamps with it. According to a further embodiment, the audio scenes of the source videos may be compared to find sufficient similarities, and on the basis of the found similarities it can be determined that the source videos are from the same event.

For creating a reasonable panorama video remix, it may not be sufficient to determine that the source videos are from the same event. For example, in some cases it may not be viable to combine a close-up video captured from a distance of a few meters to a long-distance video captured from a distance of several tens of meters. According to an embodiment, the video remix application is arranged to estimate the capturing distance between the image capturing device and the object of interest. The capturing distance may be estimated, for example, by using stereo or multiview cameras, wherein for example the viewer tracking processes may be used in estimating the distance. Then the video remix application may select a number of source videos having the capturing distance within a predefined range to be used in the panorama video remix.

However, in some other cases it may be viable to combine a close-up video and a long distance video by using various image processing methods. Thus, according to another embodiment, alternatively or in addition to estimating the capturing distance, the video remix application is arranged to find scale matching between frames of a close-up video (i.e. a short distance capture) and frames of a scenery video (i.e. a long distance capture). If, for example, an object of interest is captured in two videos, in a close-up video and in a long-distance video, whereby the object is shown larger in the close-up video than in the long-distance video, then an object matching method may be used to decide whether they represent the same object. If affirmative, then affine transform processes may be used to combine the two videos for creating a panorama video remix. The affine transform processes may include, for example, rotation transform and scale transform.

Once the source videos have been selected for the panorama video remix, they may be subjected to various editing procedures. For example, if the source videos are encoded, they need to be decoded such that they can be further processed on a frame level.

According to an embodiment, the selected source videos may have different frame rates. For example, a first source video may have a frame rate of 20 frames per second (fps) and a second source video may have a frame rate of 30 fps. As a result, the time interval between two consecutive frames of the panorama video may not be constant, but variable.

In order to create a panorama video remix on a frame level without any blurring effects, a sufficient time alignment of the selected source videos is required. The importance of time alignment is even emphasized, if the selected source videos have different frame rates. According to an embodiment, the time alignment can be achieved by analysing the audio scenes of the source videos and after having found a common background audio component, the source videos may be easily aligned in time axis. This enables to achieve a very precise time alignment compared to, for example, using capturing time stamps from the capturing devices, wherein there may easily be a deviation of several seconds.

Once the selected source videos have been aligned in time axis, the frames of the panorama video remix are created based on the time-corresponding frames of the selected source frames.

This is illustrated in the example of FIG. 3, wherein three source videos (videos 1-3) have been selected for the creating the panorama video remix. The selected source videos have different frame rates in relation each other. Now the frames of the panorama video remix are created based on one or more of the time-corresponding frames of the source videos.

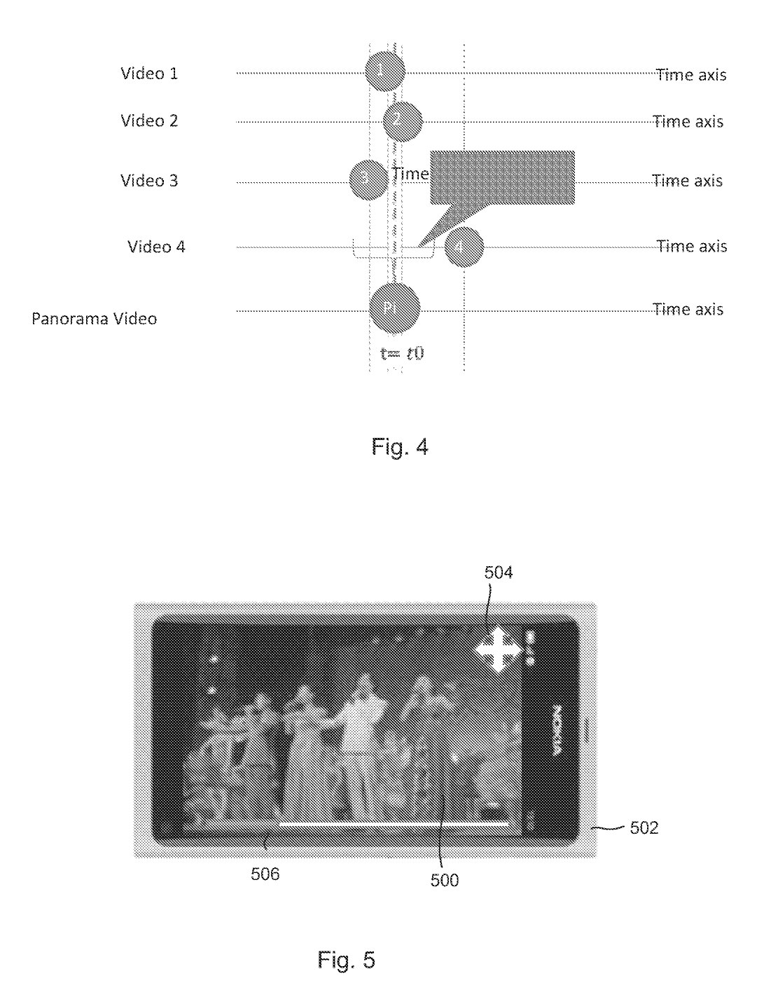

According to an embodiment, for selecting which frames of the source videos shall be used for creating a single panorama video frame, a time interval is defined, wherein the frames of the source videos within said time interval may contribute to a particular panorama video frame. This is illustrated in FIG. 4, wherein at the time point t0, the panorama video frame Pi is created based on all the available source video frames (frame 1, 2, and 3) which are within the interval δ of the time point t0. Frame 4 cannot contribute to the panorama frame Pi, because it is out of the scope of the interval δ of the time point t0. The time interval may be adjusted appropriately, for example, based on the deviation of frame rates of the source videos.

As shown in the example of FIG. 3, the first panorama video frame is created on the basis of frames from each of the three source videos. The second panorama video frame is created on the basis of frames from the source videos 2 and 3. The third and fourth panorama video frames are created on the basis of a single frame from the source videos 1 and 2, correspondingly. As a result of the different frame rates of the source videos, the time interval between two consecutive frames of the panorama video is variable.

It is possible to create a panorama video remix, wherein despite of the different frame rates of the source videos, the frame rate of the panorama video remix is constant, as shown in panorama videos 2 and 3. When using a plurality of source videos, there are source frames available at timing points for the frames of the panorama video with high probability. However, if at a timing point of panorama frame, there are no source video frames within the interval of δ, at all, then an empty frame may be used in the panorama video remix at said timing point.

Referring further back to FIG. 2, when one or more panorama video remixes have been created, they are stored in a memory of the video server 206 to be available for downloading. In FIG. 2, the video server 206 is shown for illustrative purposes as a separate processing device to the video server 205, but the implementation may as well be carried out completely in one video server. Now the original source videos used in the creation of the one or more panorama video remixes may be deleted from video server, thus releasing memory space of the video server.

The stored one or more panorama video remixes may be downloaded by a plurality of apparatuses 207, 208 capable to display video content. The apparatuses 207, 208 may, but not necessarily need to be similar or the same as the video capturing devices 201, 202, 203.

The apparatus 207, 208 preferably comprises an application for selecting a desired watching angle from the panorama video and for downloading the video data preferably only related to the selected watching angle. Thus, it is not necessary to download the full panorama video data, but only the data relating to the watching angle currently selected.

FIG. 5 shows an example of a user interface 500 of such an application implemented on a mobile phone 502. The application, also referred to as a panorama video player, is implemented in this example to look similar to an existing (prior art) video player, but the application is provided with a user interface element 504 for selecting the watching angle by moving the scene either horizontally or vertically. In FIG. 5 the user interface element 504 is shown as a functional icon having a shape of an arrowed cross to be used on a touch screen of the mobile phone 502. Nevertheless, a person skilled in the art readily acknowledges that the user interface element 504 may be implemented as any suitable control means, such as a hard-button, a soft-button, a menu function, etc. A playback timer 506 shows the temporal progress of the video.

A user of the mobile phone may select the watching angle by moving the scene with the user interface element 504, for example, horizontally, where after the video data corresponding to the selected watching angle in the panorama video will be downloaded. During the video playback, the user may change the watching angle by moving the scene again, upon which downloading of the video data corresponding to the changed watching angle in the panorama video will be started.

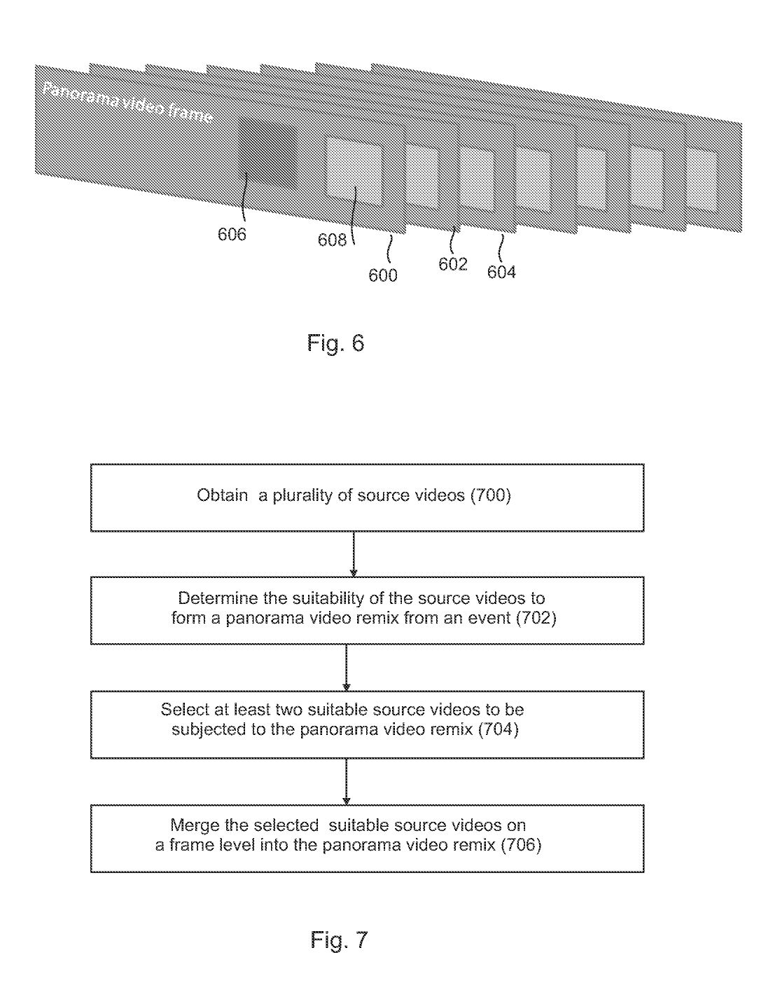

FIG. 6 illustrates the idea of a panorama video frame on a conceptual level. Each temporal panorama video frame 600, 602, 604, . . . comprises a plurality of views corresponding to the available watching angles. In FIG. 6, only two views 606, 608 are shown for the panorama video frame 600, but it is appreciated that a panorama video frame may comprise any number of views. The panorama video frames 600, 602, 604, . . . are shown in temporal order; i.e. the panorama video frame 600 represents the time T=Ti, the panorama video frame 602 represents the time T=Ti+m, the panorama video frame 604 represents the time T=Ti+n (0<m<n), etc.

Let us suppose that the user has watched the video, for example, from the watching angle corresponding to the view 606 before the time T=Ti. Now at the time T=Ti, the user wants to change the video window for watching another view of the panorama video. For example, the user may press the right arrow on the user interface element 504 to allow the video window to be moved to right from the view 606 to the view 608 at the time T=Ti. Upon moving away from the view 606, the downloading of the video data corresponding to the view 606 will be stopped and the downloading of the video data corresponding to the view 608 will be started. Now from the time T=Ti onwards the user will watch the video spatially from the view 608.

FIG. 7 shows a flow chart of the process for creating a panorama video remix from a plurality of source videos. A processing device, such as a video server, obtains (700) a plurality of source videos, which may, for example, be uploaded by one or more end-user devices or by a computer or a server connected to a network. The suitability of the source videos to form a panorama video remix from an event is then determined (702) in the processing device. This may include, for example, searching for similarities in the location information of a plurality of the source videos, or detecting a common audio scene in a plurality of the source videos. At least two suitable source videos are then selected (704) to be subjected to the panorama video remix. The selected at least two suitable source videos are merged (706) on a frame level into the panorama video remix, wherein the frames of each source video represent a watching angle to the event.

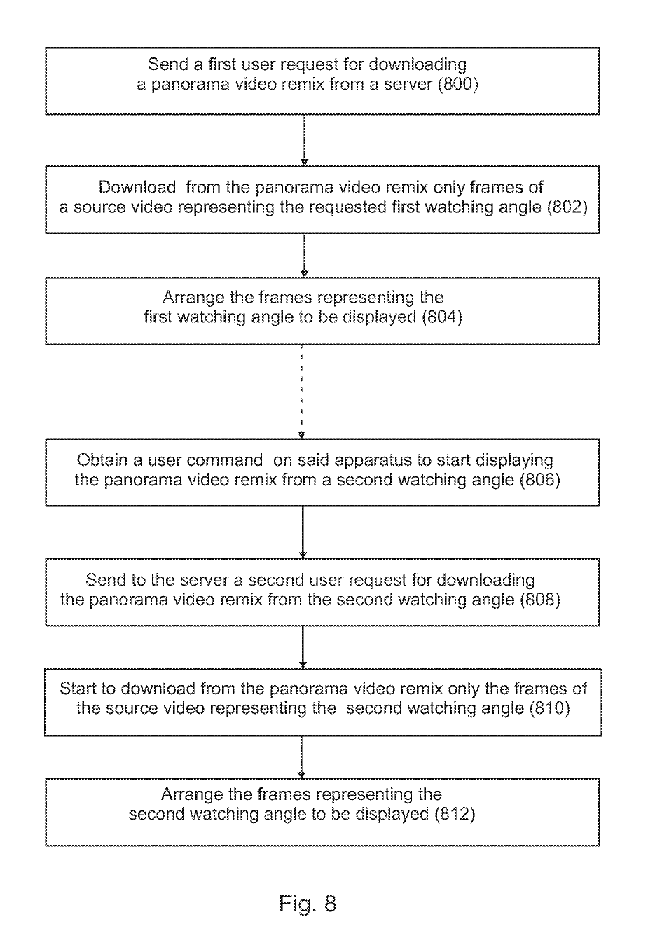

FIG. 8 shows a flow chart of the process for browsing a panorama video on an apparatus. When starting the browsing, a user of the apparatus, for example a mobile phone, sends (800) a first user request for downloading a panorama video remix from a server, wherein said user request includes a request to download the panorama video remix from a first watching angle selected by the user. The apparatus downloads (802) from the panorama video remix only frames of a source video representing the requested first watching angle. Then the apparatus arranges (804) the frames representing the first watching angle to be displayed on the apparatus.

For illustrative purposes, FIG. 8 also shows optional steps to be carried out, if the user wants to change the watching angle during the browsing. Thereupon, a user command is obtained (806) on said apparatus to start displaying the panorama video remix from a second watching angle. The user command may be given, for example, by the user interface element 504 shown in FIG. 5. The apparatus then sends (808) to the server a second user request for downloading the panorama video remix from the second watching angle. The apparatus starts to download (810) from the panorama video remix on said server only the frames of the source video representing the requested second watching angle. Then the apparatus arranges (812) the frames representing the second watching angle to be displayed on the apparatus.

A skilled man appreciates that any of the embodiments described above may be implemented as a combination with one or more of the other embodiments, unless there is explicitly or implicitly stated that certain embodiments are only alternatives to each other.

The various embodiments may provide advantages over state of the art. A wide range of source videos may be utilised, since the creation of the panorama video remix allows the source videos to be of different frame rates. The various embodiments provide a real frame-level panorama video remix with precise time alignment of the source videos. During video sharing, a user can select any angle to watch an event based on the available panorama video. Instead of downloading the full panorama video file, only the video data relating to the angle selected at a given moment is downloaded, thus avoiding redundancy in data transfer. The memory space of the video server may also be utilised more efficiently by deleting the original source videos used in the creation of the panorama video remix.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment.

Yet further, a network device may comprise circuitry and electronics for handling, receiving and transmitting data, computer program code in a memory, and a processor that, when running the computer program code, causes the network device to carry out the features of an embodiment. The various devices may be or may comprise encoders, decoders and transcoders, packetizers and depacketizers, and transmitters and receivers.

It is obvious that the present invention is not limited solely to the above-presented embodiments, but it can be modified within the scope of the appended claims.

1-41. (canceled)

42. A method comprising:
obtaining a plurality of source videos in a processing device;
determining suitability of the source videos to form a panorama video remix from an event;
selecting at least two suitable source videos for the panorama video remix; and
merging said at least two suitable source videos on a frame level into the panorama video remix, wherein the frames of each source video represent a watching angle to the event.

43. A method according to claim 42, wherein the suitability of the source videos to form the panorama video remix from the event is determined according to at least one of the following:
similarity of location information of a plurality of the source videos; and
presence of a common audio scene in a plurality of the source videos.

44. A method according to claim 43, further comprising:
comparing similarities of the audio scenes of at least two source videos; and
determining, on the basis of a predefined amount of similarities, that said at least two source videos are from the same event.

45. A method according to claim 42, further comprising:
estimating, from the source videos, a capturing distance between an image capturing device and a captured object of interest; and
selecting a number of source videos having the capturing distance within a predefined range to be used in the panorama video remix.

46. A method according to claim 42, further comprising:
searching for a common captured object of interest from the frames of at least two source videos, said at least two videos being captured with different capturing distance;
in response to detecting at least one common captured object of interest from the frames of said at least two source videos, applying at least one affine transform process to said frames of said at least two source videos in order to transform said at least one common captured object of interest in a compatible scale; and
selecting said at least two source videos to be used in the panorama video remix.

47. A method according to claim 42, further comprising
receiving a first user request for downloading the panorama video remix, said user request including a request to download the panorama video remix from a first watching angle; and
starting to download, from the panorama video remix, only the frames of the source video representing the requested first watching angle.

48. An apparatus comprising at least one processor, memory including computer program code, the memory and the computer program code configured to, with the at least one processor, cause the apparatus to at least:
obtain a plurality of source videos;
determine suitability of the source videos to form a panorama video remix from an event;
select at least two suitable source videos for the panorama video remix; and
merge said at least two suitable source videos on a frame level into the panorama video remix, wherein the frames of each source video represent a watching angle to the event.

49. An apparatus according to claim 48, wherein the suitability of the source videos to form the panorama video remix from the event is determined according to at least one of the following:
similarity of location information of a plurality of the source videos; and
presence of a common audio scene in a plurality of the source videos.

50. An apparatus according to claim 49, further comprising computer program code configured to, with the at least one processor, cause the apparatus to at least:
compare similarities of the audio scenes of at least two source videos; and
determine, on the basis of a predefined amount of similarities, that said at least two source videos are from the same event.

51. An apparatus according to claim 48, further comprising computer program code configured to, with the at least one processor, cause the apparatus to at least:
estimate, from the source videos, a capturing distance between an image capturing device and a captured object of interest; and
select a number of source videos having the capturing distance within a predefined range to be used in the panorama video remix.

52. An apparatus according to claim 48, further comprising computer program code configured to, with the at least one processor, cause the apparatus to at least:
search for a common captured object of interest from the frames of at least two source videos, said at least two videos being captured with different capturing distance;
in response to detecting at least one common captured object of interest from the frames of said at least two source videos, apply at least one affine transform process to said frames of said at least two source videos in order to transform said at least one common captured object of interest in a compatible scale; and
select said at least two source videos to be used in the panorama video remix.

53. An apparatus according to claim 48, further comprising computer program code configured to, with the at least one processor, cause the apparatus to at least:
receive a first user request for downloading the panorama video remix, said user request including a request to download the panorama video remix from a first watching angle;
start to download, from the panorama video remix, only the frames of the source video representing the requested first watching angle.

54. A computer program comprising instructions causing, when executed on at least one processor, at least one apparatus to:
obtain a plurality of source videos in a processing device;
determine suitability of the source videos to form a panorama video remix from an event;
select at least two suitable source videos for the panorama video remix; and
merge said at least two suitable source videos on a frame level into the panorama video remix, wherein the frames of each source video represent a watching angle to the event.

55. A computer program according to claim 54, wherein the suitability of the source videos to form the panorama video remix from the event is determined according to at least one of the following:
similarity of location information of a plurality of the source videos; and
presence of a common audio scene in a plurality of the source videos.

56. A computer program according to claim 55, further comprising instructions causing, when executed on at least one processor, cause the apparatus to at least:
compare similarities of the audio scenes of at least two source videos; and
determine, on the basis of a predefined amount of similarities, that said at least two source videos are from the same event.

57. A computer program according to claim 54, further comprising instructions causing, when executed on at least one processor, cause the apparatus to at least:
estimate, from the source videos, a capturing distance between an image capturing device and a captured object of interest; and
select a number of source videos having the capturing distance within a predefined range to be used in the panorama video remix.

58. A computer program according to claim 54, further comprising instructions causing, when executed on at least one processor, cause the apparatus to at least:
search for a common captured object of interest from the frames of at least two source videos, said at least two videos being captured with different capturing distance;
in response to detecting at least one common captured object of interest from the frames of said at least two source videos, apply at least one affine transform process to said frames of said at least two source videos in order to transform said at least one common captured object of interest in a compatible scale; and
select said at least two source videos to be used in the panorama video remix.

59. A computer program according to claim 54, further comprising instructions causing, when executed on at least one processor, cause the apparatus to at least:
receive a first user request for downloading the panorama video remix, said user request including a request to download the panorama video remix from a first watching angle;
start to download, from the panorama video remix, only the frames of the source video representing the requested first watching angle.

60. A method comprising:
sending a first user request for downloading a panorama video remix from a server, said user request including a request to download the panorama video remix from a first watching angle;
downloading, from the panorama video remix, only frames of a source video representing the requested first watching angle to the apparatus; and
arranging the frames representing the first watching angle to be displayed on the apparatus.

61. An apparatus comprising at least one processor, memory including computer program code, the memory and the computer program code configured to, with the at least one processor, cause the apparatus to at least:
send a first user request for downloading a panorama video remix from a server, said user request including a request to download the panorama video remix from a first watching angle;
download from the panorama video remix, only frames of a source video representing the requested first watching angle to the apparatus; and
arrange the frames representing the first watching angle to be displayed on the apparatus.

62. A computer program comprising instructions causing, when executed on at least one processor, at least one apparatus to:
send a first user request for downloading a panorama video remix from a server, said user request including a request to download the panorama video remix from a first watching angle;
download from the panorama video remix, only frames of a source video representing the requested first watching angle to the apparatus; and
arrange the frames representing the first watching angle to be displayed on the apparatus.
